(19) United States
(12) Patent Application Publication
(10) Pub. No.: US 2010/0272965 A1
(43) Pub. Date: Oct. 28, 2010

(54) METHOD AND DEVICE FOR PRODUCING A PRINTED AND EMBOSSED WEB

(75) Inventors: Wolfram Schinkoreit, Wald-michelbach (DE); Jurgen Sauter, Mannheim (DE); Dirk Mauler, Ilvesheim (DE)

Correspondence Address: YOUNG & THOMPSON, 209 Madison Street, Suite 500, Alexandria, VA, 22314, US

(73) Assignee: SCA HYGIENE PRODUCTS GMBH, Mannheim (DE)

(21) Appl. No.: 12/809,637

(22) PCT Filed: Dec. 20, 2007
(86) PCT No.: PCT/EP07/64327

§ 371 Date: Jun. 21, 2010

(51) Int. Cl. B32B 3/28; B41F 33/00; B41F 5/04; B29C 59/04

(52) U.S. Cl. 428/172; 101/483; 101/219; 156/209; 156/387

(57) ABSTRACT

Method and device for producing a printed and embossed multi-ply web (3) of tissue paper or nonwoven having a good visual appearance. A first web-shaped material (1) is embossed in a nip (6) between a first embossing roll (4) and a counter roll (5), thereby creating a set of embossments. A first ink with a first colour is applied to a first subset of the set of embossments of the first web-shaped material while the material still resides on the first embossing roll. Thereafter an adhesive is applied to a second subset of the set of embossments of the first web-shaped material (1) while the material still resides on the first embossing roll (4). After that, the first web-shaped material is combined with a second web-shaped material (2) to form a multi-ply web (3). There is also provided a printed and embossed multi-ply web (3).

### TECHNICAL FIELD

The present invention refers to a method and a device for producing a printed and embossed multi-ply web of tissue paper or nonwoven. The invention further refers to a printed and embossed multi-ply web of tissue paper or nonwoven.

### BACKGROUND OF THE INVENTION

It is common to emboss and print webs of tissue paper or nonwoven. Embossing is a way of increasing the bulk of the paper and it also gives a three-dimensional structure to the paper, which improves the absorption properties and also the aesthetic appearance of the tissue product. Embossing may further be a way of laminating two or more tissue paper plies together, at which a mechanical joining of the plies occurs in the embossing sites. Embossing is often combined with gluing for laminating tissue paper plies. This is for example disclosed in U.S. Pat. No. 3,414,459, in which laminating of tissue plies by a combined embossing and gluing procedure is shown. The embossing is of so-called “foot-to-foot” type according to which the raised protuberances of the embossed tissue plies are joined together. U.S. Pat. No. 3,867,225 also discloses a combined embossing and gluing process, but where the embossing is of so-called “nested” type according to which the raised projections of one tissue ply will rest in and be joined to the depressions of the opposite Ply.

Such webs of tissue paper or nonwoven are normally used to produce products like toilet paper, household towels, hankies, facial tissues, hand wipes, object wiping and napkins.

Printing of tissue products is often made for aesthetic reasons. The printing pattern could be any pattern including more or less continuous lines, line segments, dots, trademarks, logotypes, symbols, fantasy characters etc. One or more colours could be used. One conventional way of embossing and printing a multi-ply tissue product is to perform the embossing and lamination of the plies first and subsequently the printing. This method will result in that the printing ink will be on the outside of the product. Since the surface of the product no longer is flat due to the embossing, ink transfer will not be perfect, especially in the areas where the product has depressions due to the embossing.

According to an alternative method the printing of one tissue ply is made first and subsequently this tissue ply is embossed and laminated with another tissue ply. A drawback with such a method is that the ink is not always completely dry before the embossing, which involves the risk that the printing will be blurred. The tissue plies will also undergo a local deformation at the embossed areas which will deform the printed areas.

U.S. Pat. No. 5,339,730 teaches a method to make a product having two or more plies. A first ply is embossed and then printed while being on a first embossing roller. A second ply is embossed by a second embossing roll and adhesive is applied to it. Thereafter the two plies are joined to a combined web so that the print on the first ply is on the side facing the second ply. Ink and adhesive are thus applied to different plies.

If ink and adhesive are applied to different plies, the print looks best, when the combined web is seen from the side of the printed ply. The adhesive helps to stiffen the embossments of the other ply. The embossments of the ply, whereupon adhesive was applied, therefore look better than those of the printed ply, so the embossments look best, when the combined web is seen from the side of the second ply. The user of the product thus either sees the print or the embossments in the best way.

Visual appearance has become a more and more important property for tissue products. It plays an important part when the buyer and/or user make his/her choice of product. It is therefore important to make a product having a superior visual appearance.

### SUMMARY OF THE INVENTION

The object of the present invention is provide to a method and a device for producing a 30 printed and embossed multi-ply web of tissue paper or nonwoven having a good visual appearance. The invention further refers to a printed and embossed multi-ply web of tissue paper or nonwoven, having a good visual appearance. The printed and embossed multi-ply web comprises two, three, four or more web-shaped materials.

Since perfect register keeping is achieved by keeping the first web-shaped material at the first embossing roll while embossing, printing and applying adhesive, register keeping is possible without using complex machinery or complex control systems.

The method comprises the steps of
embossing a first web-shaped material in a nip between a first embossing roll and a counter roll, thereby creating a set of embossments;
applying a first ink with a first colour to a first subset of the set of embossments of the first web-shaped material while the material still resides on the first embossing roll;
applying an adhesive to a second subset of the set of embossments of the first web-shaped material while the first web-shaped material still resides on the first embossing roll;
combining the first web-shaped material with a second web-shaped material to form a multi-ply web while the first web-shaped material resides on the first embossing roll.

In general terms, a subset is a set which has some of the elements of another set, called superset, but does not have any elements that the superset does not have. The subset might also have all of the elements in the superset. In this invention, the superset comprises all embossments produced by the first embossing roll, and is called the set of embossments. A subset of the set of embossments comprises parts of these embossments or all.

By keeping the first web-shaped material on the first embossing roll during printing, adhesive application and combining, the embossments are supported from behind while ink and adhesive are applied to the tops of the embossments. The support prevents collapsing. The ink and adhesive are located at the embossments, thereby reinforcing the impression of the embossments, resulting in a very good visual appearance. Glued embossments will also be prevented from collapsing in the product afterwards. The glued embossments will help the product to keep its bulk both in a dry and wet state.

By the term “glued embossments” is meant embossments having an adhesive applied to them. The term gluing is used for applying an adhesive.

The above method also makes it possible to keep the printing and gluing in absolute register. There is no risk that the material would stretch or deform in any other way in between the printing and gluing.

It is preferred to first perform the printing of the ink and then the application of adhesive. By that order, the risk of contaminating the printing unit with adhesive is avoided. The order could however be performed the other way around, that is adhesive application first and then printing.

The printed embossments of the first subset can be all or a number of the embossments in the set of embossments created in the embossing step. The glued embossments of the second subset can be all or a number of the embossments in the set of embossments. Normally, the first and second subsets of the set of embossments at least partly coincide, but they can also be complementary, e.g. having no embossments in common. It is preferred that at least parts of the subsets coincide, so that there will be visual combination effects of adhesive and ink. In the end, the combined webs can thus comprise embossments of four kinds: without adhesive or ink, solely printed embossments, solely glued embossments and embossments that are both glued and printed. A product produced by the described method could also comprise embossments belonging to one, two or three of the above-mentioned kinds as long as at least some embossments are glued and some printed.

Moreover, parts of the embossments in the set of embossments may be glued or printed. Hence, the first subset may comprise all embossments of the set of embossments, but ink be applied only to parts of said embossments. Similarly, the second subset may comprise all embossments of the set of embossments, but adhesive be applied only to parts thereof. Also in this case, the ink pattern may be complementary or at least partly coincide.

It is also possible that the first subset of the set of embossments has some embossments that are completely covered with ink and some that are partly covered. In the same way, the second subset could have some embossments that are completely covered with adhesive and some that are partly covered.

The adhesive can be normal uncoloured adhesive or it can be coloured with a second colour. Normally the second colour is different from the first colour. Preferably, the adhesive is coloured with a second colour, in order to get visual combination effects between adhesive and ink. It is also a convenient way of using a second colour, instead of having to add an extra printing unit.

The method can further comprise a step wherein an additional colour is applied as an ink or a coloured adhesive to at least one additional subset of the set of embossments of the first web-shaped material while the first web-shaped material still resides on the first embossing roll in an additional application unit before combining the web-shaped materials. In the same way as mentioned above, register is kept by keeping the first web-shaped material on the first embossing roll. It is possible to add as many inks or adhesives as wanted. Increasing the diameter of the first embossing roll would provide space for additional added units.

When using many colours, it is preferred that they are mixable with each. Mixable is not restricted to that the ink and adhesives are physically mixed with each other. Instead the term mixable is to be understood in a broad sense relating to how the combined colours are perceived. If the colours are mixable, the combined colour will have another shade than the original colours.

If using the colours yellow, cyan and magenta, which are normal colours of colour printing, almost any shade in the colour triangle can be provided.

In an embodiment the inks are applied by means of flexographic printing. The adhesive could also be applied by a similar arrangement using adhesive instead of ink.

The first and second web-shaped material could be treated individually before combining. They could for example be exerted to a three-dimensional patterning provided on the material while wet, during drying of the wet material and/or in the dry state. These treatments comprise forming a paper on a patterned fabric, while being produced in a paper machine, as for example a TAD paper. They also comprise any form of pre-embossing made prior to the combination of materials. The materials could also be printed with an independent print pattern or a chemical could be applied.

It is also possible to treat the multi-ply web after combining by further embossing or printing. This also includes application of chemicals like lotion or wetting agents.

In an embodiment, the combination of the web-shaped materials is done with flat marrying in a nip between the first embossing roll and a marrying roll having a substantially flat surface. The embossments of the first web-shaped material will be supported from the back side by the first embossing roll.

In an alternative embodiment, combination of the web-shaped materials is done with foot-to foot technology. The combination is then done in a nip between the first embossing roll and a second embossing roll, where a substantial part of the protuberances of the second embossing roll are substantially opposite the protuberances of the first embossing roll.

In a further alternative embodiment, combination of the web-shaped materials is done with nested technology. A second embossing roll embosses the second web-shaped material and the two web-shaped materials are combined so that a substantial part of the embossments of the second web-shaped material lie in-between the embossments of the first web-shaped material.

In another embodiment of the invention, the method further comprises a step wherein at least one additional web-shaped material is added before the step of combining the web-shaped materials. On way of doing this is placing the at least one additional web on the first web-shaped material before the first web-shaped material is combined with the second web-shaped material. The at least one additional web-shaped material could then be embossed between the first embossing roll having the first web-shaped material on top of it, and a counter roll, and subsequently a new subset of the set of embossments are printed or glued, by applying ink or adhesive on top of the additional web-shaped material. The combination is done in any of the above-mentioned ways.

In a preferred embodiment, at least one web-shaped material has been embossed over at least parts of its surface giving the web-shaped material an embossed thickness which is substantially adding to the thickness of the multi-ply web. This is particularly useful when bulky products are wanted.

The invention further refers to a device for producing a multi-ply web of tissue paper or nonwoven. The device comprises
a first embossing roll having a three dimensional first pattern of protuberances;
a counter roll arranged to run against the first embossing roll;
at least one printing unit arranged to run against the first embossing roll;
at least one adhesive application unit arranged to run against the first embossing roll
at least one unit for combining different plies of the web comprising a marrying roll arranged to run against the first embossing roll.

In an embodiment, at least one printing roll is adapted to carry an ink in a first pattern, whereby the ink-carrying regions coincide with a first subset of the protuberances of the first embossing roll.

In another embodiment, at least one adhesive application roll is adapted to carry an adhesive in a second pattern, whereby the adhesive-carrying regions coincide with a second subset of the protuberances of the first embossing roll.

These embodiments could be freely combined, using a print pattern and an adhesive pattern, a print pattern or an adhesive pattern, or using neither a print pattern nor an adhesive pattern.

The printing rolls could be flexographic printing rolls.

Additional printing units could be added, as well as additional adhesive application units.

In an embodiment the device comprises three or four printing rolls and an adhesive application roll, all placed before the last unit for combining. Such an embodiment could be used for 4-colour printing.

In addition, the invention refers to a printed and embossed multi-ply web of tissue paper or nonwoven, or a laminate of tissue paper and nonwoven, wherein at least a first outer ply has a first pattern formed by a set of embossments, facing inwards in the web, and wherein a first subset of the set of embossments is printed with a first ink having a first colour, at least a second subset of the set of embossments is glued by an adhesive to a second ply, the ink and adhesive is applied in synchronisation with the subsets of the set of embossments, and the geometrical relation between the first and second subsets of the set of embossments repeat in a regular way.

The first pattern of embossments, formed by the first embossing roll, repeats after one pattern report or a full circumference of the first embossing roll, if the report is the whole circumference. In the same way, the first and second subsets repeat after a pattern report or after a circumference of the first embossing roll. Since the first and second subsets are subsets of the set of embossments created in the embossing step, they will keep their geometrical relation to each other and to the first pattern of embossments. They will repeat every revolution or every pattern report, consequently they repeat in a regular way.

In an embodiment, the embossments of the first and second subset of the set of embossments have substantially the same depth.

The subsets of the set of embossments could either coincide, at least partly, or be complementary. Preferably the subsets at least partly coincide in order to get visual combination effects.

The adhesive combining the plies could be uncoloured or coloured. If the product is multicoloured, it is preferred to add one of the colours in the adhesive.

At least one additional subset of the set of embossments could be printed with an additional ink having an additional colour. If more than one colour is used, the perceived colours of embossments, where the subsets of the set of embossments coincide, could be a mix of the applied colours. Such colour mixes could be between ink colours or between ink colours and adhesive colours.

The embossments in the first outer ply can form a design embossing. At least one of the plies could comprise a background embossing, in addition to the glued or printed embossments.

A second outer ply could be substantially flat or have a background embossing. It is attached to the first outer ply by means of nested technology, foot-to-foot technology or flat marrying. The attachment is done by means of adhesive in the glued areas. Other lamination technologies are also possible.

At least one additional ply could be added. The multi-ply product can have three, four, five or more plies. For example, when using a third ply situated between the first outer ply and the second ply, the third ply could have the same pattern of embossments as the first outer ply and the third ply could have a third subset of the set of embossments printed with another ink having a colour different from the first colour.

In a preferred embodiment, at least one ply is embossed over at least parts of its surface giving the ply an embossed thickness which is substantially adding to the thickness of the multi-ply web. This is particularly useful, when a bulky multi-ply product is wanted.

### BRIEF DESCRIPTION OF THE DRAWINGS

FIG. 1 is a schematic side view of an embodiment of a device for performing the method according to the invention.

FIG. 2a is a schematic plan view of embossments in a first web-shaped material

FIG. 2b is a print pattern which may be printed on the first web-shaped material

FIG. 2c is an adhesive pattern which may be applied to the first web-shaped material

FIG. 2d is a schematic plan view of a first web-shaped material after printing and gluing

FIG. 3 is a plan view of an embodiment of a product according to the invention.

FIG. 4 is a schematic cross-section of the product in FIG. 3

FIG. 5 is a schematic side view of an embodiment of a device for performing the method according to the invention.

FIGS. 6a to 6d are schematic views of a first web-shaped material after subsequent process steps

FIG. 7 is a schematic side view of an embodiment of a device for performing the method according to the invention.

FIG. 8 is a schematic cross-section of an embodiment of a product according to the invention.

FIG. 9 is a schematic cross-section of an embodiment of a product according to the invention.

FIG. 10 is a schematic cross-section of an embodiment of a product according to the invention.

### DETAILED DESCRIPTION OF PREFERRED EMBODIMENTS

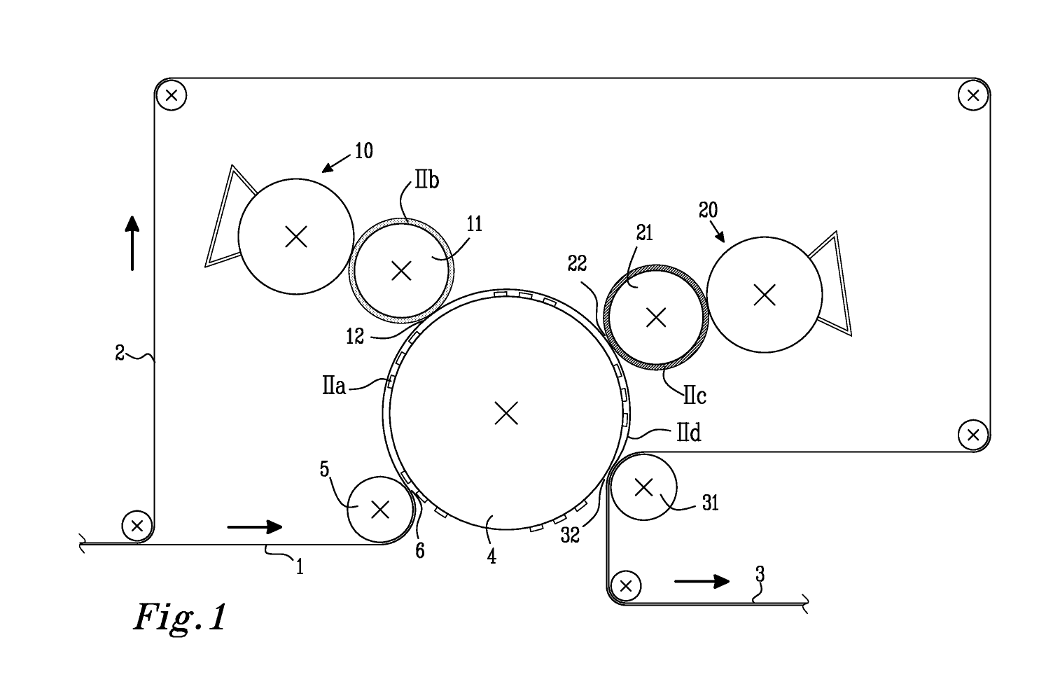

FIG. 1 shows a device for producing a printed and embossed web of tissue paper or nonwoven. A first web-shaped material 1 is fed through a nip 6 between a first embossing roll 4 and a counter roll 5. The first embossing roll has protrusions corresponding to the desired embossments in the web-shaped material. A typical material for the embossing roll could be steel, which might be chrome-plated. Alternatively, the embossing roll could be made of a polymer like hard rubber, ebonite or plastics. If there is a need to often change embossing patterns, it is preferred to have a system for quick change of embossing roll, for example using embossing sleeves, embossing plates or having the possibility to easily open up the device and be able to lift out the embossing roll.

The counter roll 5 could be made of a for example rubber, steel or paper. If the material is steel or paper, the circumferences of the counter roll 5 and the first embossing roll 4 should preferably be the same or close to the same, or one circumference should be a multiple of the other. If the material is rubber, which is most common, it is preferred to choose the circumference of the counter roll so that it does not match with the circumference of the embossing roll in order to even out the wear.

When the first web-shaped material 1 is going through the nip 6, the first web-shaped material 1 will be deformed in the areas corresponding to the protrusions of the first embossing roll 4. The protrusions will give rise to an embossing pattern, which comprises a set of embossments, where the embossments in the web-shaped material reflect the protrusions of the first embossing roll.

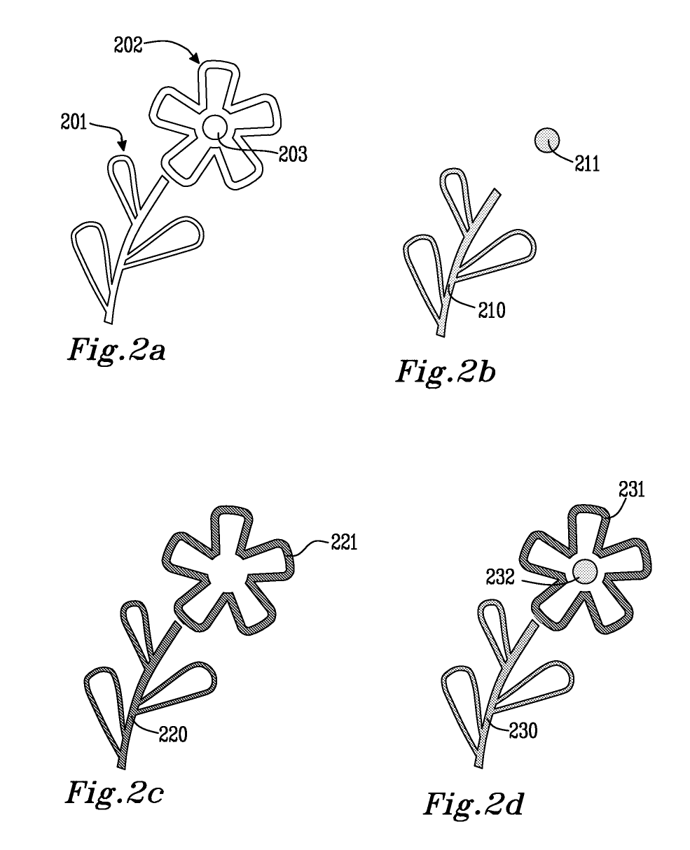

FIG. 2a is a plan view of a first web-shaped material after passing nip 6 according to an embodiment of the invention. In this example a decorative element in the form of a flower is shown. The flower comprises three embossments of the first web-shaped material, an embossment forming the stem 201, an embossment forming the petals 202 and an embossment forming the centre of the flower 203. Each embossment corresponds to a protrusion of the first embossing roll 4.

While residing on the first embossing roll the first web-shaped material is printed by a printing roll 11 in a printing nip 12. The printing unit 10 comprises an ink chamber, an anilox roll and the printing roll 11. A fountain roll could be used instead of the ink chamber. In the illustrated embodiment, the printing roll 11 carries its ink in a first print pattern. The pattern is preferably made in such a way that it matches the embossing pattern at least partly, i.e. ink is printed on the tops of at least some of the embossments.

The printed embossments then compose a first subset of the set of embossments. In this embodiment, no ink is printed on the web-shaped material in between the embossments. The circumferences of the printing roll and the first embossing roll should then preferably be the same or close to the same, or one circumference should be a multiple of the other. It is also possible to have patterns formed by reports. A patterned roll then has a number of reports around its circumference. A report is the repetition length of the pattern, i.e. after a report's length the same pattern appears again. The match between the printing pattern and the embossing pattern could therefore be made by means of using the same report length. The circumferences could then for example be arranged so that the circumference of the printing roll is two reports long and the circumference of the first embossing roll is five reports long. Of course, any integer number of reports could be used. The print pattern and embossing pattern could also be matched by adjusting their rotational speeds, so that they have the same time for one revolution, so that the time for one revolution for one of the rolls is a multiple of the other or so that any reports match each other.

The printing roll 11 could be a flexographic printing roll, where the print pattern is composed of elevated surfaces, which carry the ink on their top surfaces.

In an alternative embodiment, the printing roll 11 carries ink all over the surface. The first web-shaped material 1 will then be printed on the tops of all embossments. In this case the first subset of the set of embossments comprises all embossments. Normally, no ink is printed on the web-shaped material in between the embossments, since the material only is in contact with the printing roll 11 at the embossments in the printing nip 12. In another embodiment, the printing roll 11 has a certain percentage of its surface covered by ink. The percentage is the same over the whole printing roll surface area. This could lead to that some of the embossments are partly printed. If the printing roll 11 carries the ink all over the surface or with a certain percentage over the surface, the circumferences of the printing roll and the first embossing roll could be chosen independently of each other.

FIG. 2b shows a print pattern on the printing roll 11. The print pattern partly matches the embossed decorative element of FIG. 2a. The print area 210, the stem of the flower, corresponds to the embossment 201, i.e. the ink is printed on top of the embossment 201 in the printing nip 12. In the same way, print area 211, the centre of the flower, is printed on top of embossment 203. The first subset of the set of embossments comprises embossments 201 and 203.

In the illustrated embodiment in FIG. 1, the first web-shaped material is kept on the first embossing roll 4 and is transported to a nip 22 between the first embossing roll 4 and an adhesive application roll 21. The adhesive application unit 20 comprises an adhesive chamber, an anilox roll and the adhesive application roll 21. A fountain roll could be used instead of the adhesive chamber. The adhesive application roll 21 carries its adhesive in an adhesive pattern. The pattern could be made in such a way that it matches the embossing pattern at least partly, i.e. adhesive is applied to the tops of at least some of the embossments. The glued embossments then compose a second subset of the set of embossments. In this embodiment, no adhesive is applied to the web-shaped material in between the embossments. The match between the adhesive pattern and the embossing can be made in the same way as described above for the printing roll 11. The adhesive application roll could be a flexographic printing roll, which carry adhesive instead of ink.

In an alternative embodiment, the adhesive application roll 21 carries adhesive all over the surface. The first web-shaped material will then be glued on the top of all embossments and the second subset would comprise all embossments. Normally, no adhesive is applied on the web-shaped material in between the embossments, since the material only contacts the adhesive application roll where the embossments are in the nip 22. In another embodiment, the adhesive application roll has a certain percentage of its surface covered by adhesive. The percentage is the same over the whole adhesive application roll. This could lead to that some of the embossments are partly glued. If the adhesive application roll carries the ink all over the surface or with a certain percentage over the surface, the circumferences of the adhesive application roll and the first embossing roll could be chosen independently of each other.

In the illustrated embodiment, a coloured adhesive is used. This is especially useful in embodiments using an adhesive application roll 21 carrying an adhesive pattern.

FIG. 2c shows the adhesive pattern of adhesive application roll 21. In this example, the adhesive pattern forms the petals 221 and the stem 220. The adhesive is transferred to embossments 201 and 202. On embossment 201, adhesive is applied on the ink printed in the printing nip 12. On embossment 202, adhesive is applied directly to the first web-shaped material. The second subset of the set of embossments comprises embossments 201 and 202. In the illustrated embodiment, the first subset of the set of embossments, printed in nip 12, is different from the second subset of the set of embossments, glued in nip 22.

FIG. 2d is a plan view of the first web-shaped material after printing and adhesive application. In the area of the stem 230, adhesive has been applied on top of ink. If for example, the ink is yellow and the adhesive coloured blue, these two colours will combine and make the stem 230 be perceived as green. The area of the petals 231 is embossed and glued and will look blue, like the blue colour of the adhesive. The area 232 of the centre of the flower is embossed and printed yellow.

After the nip 22 the first web-shaped material 1 resides on the first embossing roll 4. A second web-shaped material 2 is then brought in contact with the first web-shaped material 1. They are both brought through a marrying nip 32 between a marrying roll 31 and the first embossing roll 4. In the marrying nip the second web-shaped material is glued to the first web-shaped material in the areas of the embossments where adhesive was applied in the nip 22. The marrying roll 31 could be of a soft material like rubber. It could also be a steel roll, or have a hard shell on top of a softer core, or any other material used for marrying rolls. Marrying could alternatively be made in an external nip not involving the first embossing roll 4.

In the embodiment shown in FIG. 1, combining of the two web-shaped materials is made with flat marrying. The web-shaped materials are then combined in a marrying nip 32 between the first embossing roll and a flat marrying roll. The second web-shaped material is substantially flat. In the marrying nip 32, it is pressed together with the first web-shaped material between the first embossing roll 4 and the marrying roll 31. Depending on the nip pressure and the material of marrying roll 31, the second web-shaped material stays flat in the nip, gets compressions corresponding to the protrusions of the first embossing roll 4 or gets slight protrusions corresponding to the protrusions of the first embossing roll 4.

It is also possible to use a marrying roll with a structured surface. The protrusions of the marrying roll should then match the protrusions of the first embossing roll 4. The match is then done in a similar way as for the printing roll as described above. On the contrary, when using a flat marrying roll, the circumference should be chosen independently, in order to even out wear.

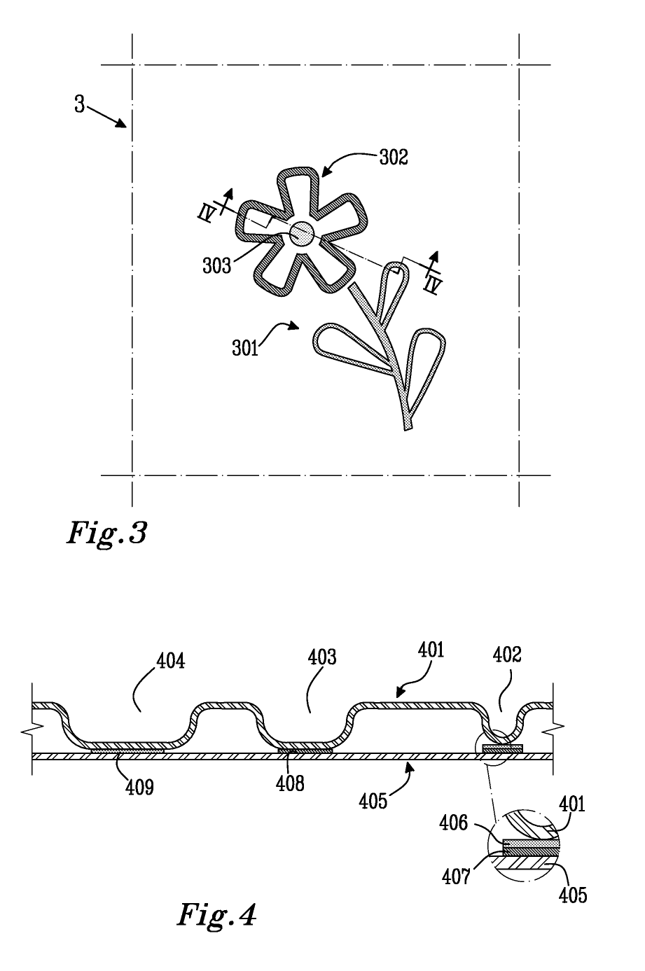

FIG. 3 is a plan view of a part of a multi-ply product comprising the combined web-shaped material 3. The product is seen with the first web-shaped material facing upwards. Using the colours mentioned above, the stem 301 looks green, the petals 302 blue and the centre of the flower 303 yellow. The whole flower is composed of three coloured embossments, where two of them, 301 and 302 are glued to the other outer ply.

FIG. 4 shows a cross-section of FIG. 3 along the line IV to IV. The first web-shaped material, forming a first outer ply 401, has a number of embossments 402 to 404. 402 is a cross-section through embossment 201 of FIG. 2a forming the stem. 404 is a cross-section of embossment 202 forming the petals. 403 is a cross-section of embossment 203 forming the centre of the flower. Ink has been printed in areas 406 and 409, on embossments 402 and 404, corresponding to the first subset of the set of embossments, comprising embossments 201 and 203 of FIG. 2a.

The second web-shaped material, forming a second outer ply 405, is glued to the first web-shaped material 401 by means of adhesive in areas 407 and 408, on embossments 402 and 403, corresponding to the second subset of the set of embossments comprising embossments 201 and 202. On embossment 402, ink has first been applied on top of the first web-shaped material in ink areas 406. Thereafter adhesive was applied on the same embossment in adhesive area 407. In other words, the first and second subsets of the set of embossments partly coincide, since they have an embossment in common, 201, and other embossments, 202 and 203, which are not in common. If the ink areas 406 and 409 were yellow and the adhesive areas 407 and 408 blue, the embossment 402, corresponding to embossment 201, would look green (perceived combination of yellow and blue). Embossment 403, corresponding to embossment 202, would look blue due to the blue-coloured adhesive. Embossment 404, corresponding to embossment 203 would look yellow.

The combined web material will look best when seen from the side where the first web-shaped material is facing outwards, that is seen from above in FIG. 4. The viewer then sees a printed pattern on a first subset of the the set of embossments. Since the ink is printed on the material, the viewer sees a distinct and clear pattern. He/she also sees the embossments in the first web-shaped material, of which a second subset is stiffened by adhesive, which might be coloured. The perfect register between adhesive, ink and embossments enhances the visual impression.

In the set-up of FIG. 1, the best-looking side is facing downwards after the marrying nip 32. This must be considered when further processing the combined web into products, e.g. by folding or winding up to small rolls. For instance, when making a toilet roll, the roll should be wound in such a way that the best looking side is facing outwards in the toilet roll. As an alternative, it would be possible to change the set-up of a device according to an embodiment of the invention, in such a way that the best-looking side is facing upwards after marrying. If the device according to the invention is used to rebuild an existing converting line, it is preferred to use this alternative set-up.

In the illustrated embodiment in FIGS. 1 to 4, the first subset of the set of embossments comprises the embossments printed in nip 12. The second subset comprises the embossments glued in nip 22. In other embodiments, the first subset could coincide with the total set, which would mean that all embossments were printed. Normally however, not all embossments are printed. In the same way the second subset could coincide with the total set, meaning that all embossments were glued, but normally they do not. Further, the first subset could be a subset of the second subset and vice versa. The may also be the same. Normally, the first subset and second subsets are different from each other and partly overlapping, that is some embossments only belong to the first subset, others only to the second subset and some embossments to both. The first and second subset might also be complementary, that is they have no embossments in common.

It is also possible to only partly cover an embossment with ink or adhesive. This would for example occur when using a flexographic printing roll whose protrusion is at the corresponding position as an embossment in the web-shaped material, but where the top surface of the protrusion is smaller than the top surface of the embossments or only is a part of the embossment.

It would also be possible to use halftone printing, which is a well-known printing technology. By that, the inks could be printed in any shade between 0% and 100%, that is from very light to full dark.

The web-shaped material could comprise one ply. It could also comprise more than one ply, for example two, three or four plies. It is also possible that it comprises two or more plies having different properties, for example different grammage, different stretches, different colour, different background embossing or different raw material. Since ink and/or coloured adhesive is applied on the inside of the first web-shaped material, at least one of the web-shaped materials 1 and 2 should be at least partly transparent, so that colour can be seen through the material.

A tissue paper is defined as a soft absorbent paper having a basis weight below 65 g/m² and typically between 10 and 50 g/m². Its density is typically below 0.60 g/cm³, preferably below 0.30 g/cm³ and more preferably between 0.08 and 0.20 g/cm³. The tissue paper may be creped or non-creped. The creping may take place in wet or dry condition. It may further be foreshortened by any other methods, such as so called rush transfer between fabrics.

The fibres contained in the tissue paper are mainly pulp fibres from chemical pulp, mechanical pulp, thermo mechanical pulp, chemo mechanical pulp and/or chemo thermo mechanical pulp (CTMP). The fibres may also be recycled fibres. When pulp fibres are used it is assumed that pulp fibres of all different kinds normally used in tissue manufacturing are comprised. Also other pulp of cellulose fibres can be used, like cotton linters, bast cells such as ramie, linen and jute, straw pulp, bamboo pulp, bagasse, sisal, rice straw and hemp. The tissue paper may also contain other types of fibres enhancing e.g. strength, absorption or softness of the paper. These fibres may be made from regenerated cellulose or synthetic material such as polyolefins, polyesters, polyamides etc.

A nonwoven material is defined as a manufactured sheet, web or batt of directionally or randomly orientated fibres, bonded by friction, and/or cohesion and/or adhesion, excluding paper, and products which are woven, knitted, tufted, stitch-bonded incorporating binding yarns or filaments, or felted by wet-milling, whether or not additionally needled. The fibres may be of natural or man-made origin. They may be staple or continuous filaments or be formed in situ

In FIG. 1, lamination between the first and second web-shaped material is made by means of gluing the web-shaped materials to each other by means of applying an adhesive to embossments. Other lamination technologies could of course be used, for example mechanical embossing, either all over the surface or along the edges, union embossing (type of mechanical), hot melt lamination or spraying of adhesive. In such an embodiment, the adhesive application unit 20 could be replaced by an additional printing unit.

The adhesive could be any adhesive normally used for laminating web-shaped materials. If the web material is tissue paper, the adhesive could for example be polyvinyl alcohol, carboxy methyl cellulose, ethylene vinyl acetate, polyvinyl acetate, ethylene acrylic acid, vinyl acetate acrylic acid, styrene acrylic acid, polyurethane, polyvinylidene chloride, starch, chemically modified starch, dextrine, water soluble polymers such as latexes and milky colloids in which natural or synthetic rubber or plastic is suspended in water. If another web-shaped material is used, an adhesive suitable for that should be chosen. The term glued is used generally; it is not restricted to applying glue, instead any adhesive could be applied. In the same way, the term gluing is used for applying an adhesive.

The ink could be any ink normally used for printing web-shaped materials, e.g. paper or nonwoven. The ink should be adapted to the properties of the web-shaped material and the printing process used. Any known printing process could be used. In a preferred embodiment flexographic printing is used.

If the adhesive is coloured, it is preferred that the colour of the adhesive and of the ink are mixable with each other. Mixable is not restricted to that the ink and adhesives are physically mixed with each other. Instead the term mixable is to be understood in a broad sense relating to how the combined colours are perceived. If the colours are mixable, the perceived combined colour will have another shade then the original colours. Which shade depends on in which proportions they are mixed. This is a well-known principle from for example colour printing. If more than one ink is used, the inks should be mixable with each other as well as with the adhesive.

In 4-colour printing on for example paper, a so called subtractive colour mix is used. Primary colours are cyan, magenta, yellow and a key colour, normally black. By subtractive colour mix is meant that the incident light is selectively reflected. By means of combining cyan, magenta, yellow colours and halftone printing a surface can be perceived as having almost any colour within the colour triangle. Black is in principle not needed, since a combination of cyan, magenta and yellow would give grey or black, but black colour is used to enhance contrast. It is also cheaper to print black colour than to print cyan, magenta and yellow on top of each other. For tissue, a typical printing order is first colour yellow, second magenta, third cyan and last black.

Extra printing units could be placed between the printing unit 10 and the adhesive application unit 20 while the first web-shaped material 1 still resides on the first embossing roll 4. In an embodiment, three printing units are used followed by an adhesive application unit. It is then possible to use the colours of normal 4-colour printing, if three of the colours are applied as inks and the fourth colour is applied as coloured adhesive. Alternatively, four printing units can be used and an uncoloured adhesive.

A drying unit could be placed after a printing unit, to dry the ink before the next step. This could be useful when so much ink is used, that it has not dried before the next process step.

For control of web tension, web tension units could be used for the individual web-shaped materials 1 and 2, as well as for the combined web 3.

In a preferred embodiment, the first embossing roll is driven as a master. The printing and adhesive application units are preferably driven by servo drives.

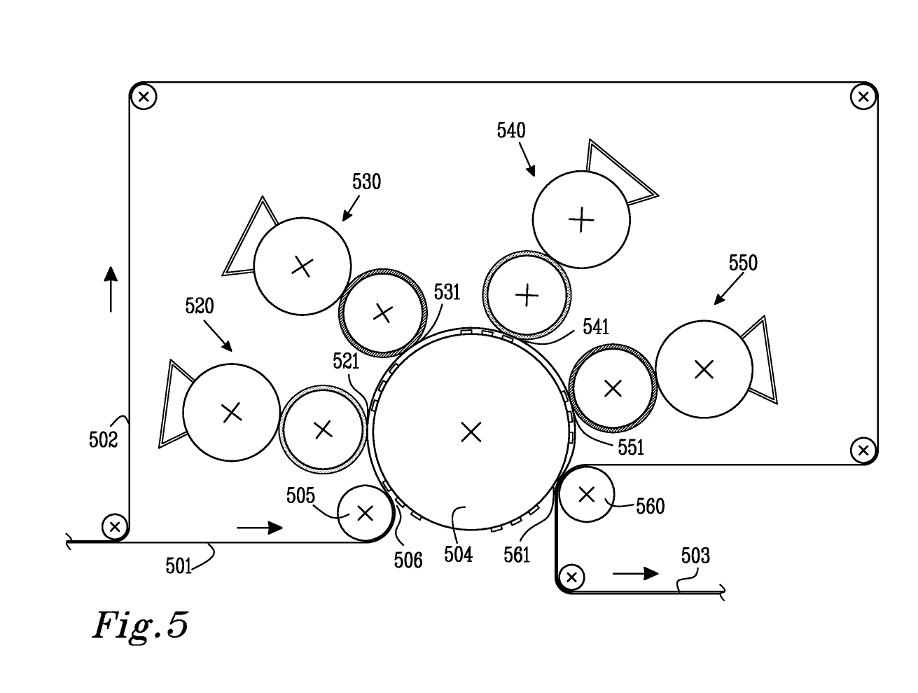

FIG. 5 shows an example of an embodiment using three colours and adhesive. The first web-shaped material is embossed between the first embossing roll 504 and a counter roll 505 in a nip 506. A first printing unit 520 prints yellow ink. A second printing unit 530 prints magenta ink. A third printing unit 540 prints cyan ink. An adhesive application unit 550 applies adhesive to a subset of the set of embossments. The first web-shaped material is combined with the second web web-shaped material in nip 561.

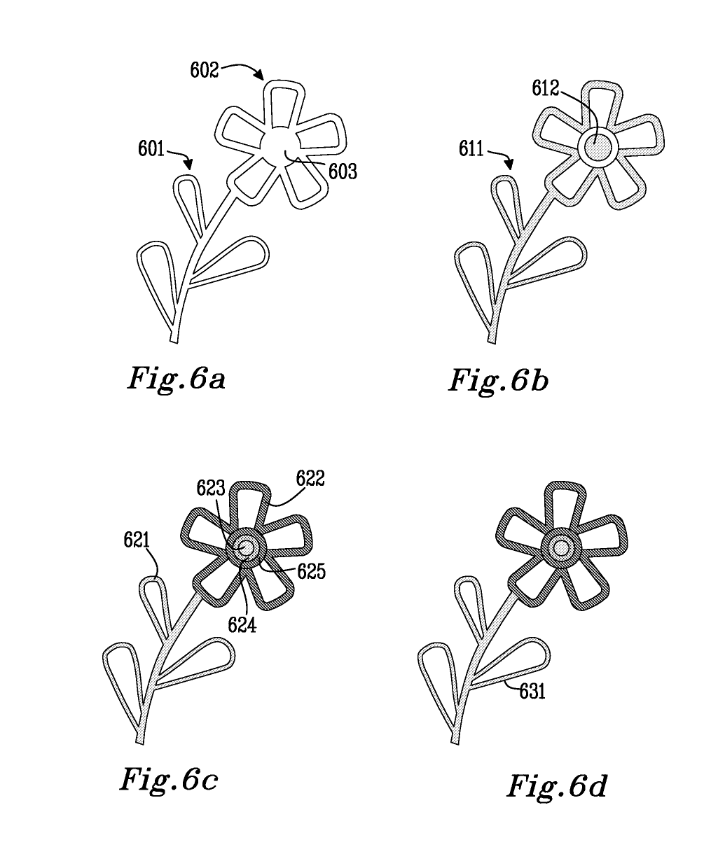

FIG. 6a shows a plan view of the web-shaped material after being embossed in the nip 506. The whole illustrated flower is one embossment, comprising three parts: 601 is the stem, 602 the petals and 603 the centre. There are no interrupting unembossed areas in between the parts. Instead the parts are continuously connected.

FIG. 6b is a plan view of the web after a nip 521. Parts of the embossed area has been printed with yellow ink. Embossment parts 601 and 602 are completely covered with yellow ink forming printed area 611, while part 603 is partly covered, being yellow at its midpoint forming printed area 612.

FIG. 6c is a plan view of the web after nip 531 where magenta is printed. Magenta is printed to the embossment part 602 forming the petals all over. On embossment part 603, the centre of the flower, magenta is printed along the circumference with a small overlap with the yellow print. The result on the web has a yellow stem 621 (printed with yellow ink), orange petals 622 (printed with yellow and magenta) and a centre of the flower, whose midpoint area 623 is yellow and whose area around the circumference 625 is magenta, and the area in-between, 624, is orange (perceived combination of yellow and magenta).

FIG. 6d is a plan view of the web after nip 541 where cyan is printed. Cyan is printed to the embossment part 601 all over. The result on the web therefore has a green stem 631 (printed with yellow and cyan). The petals and the centre of the flower were not influenced in this step.

Adhesive application unit 550 applies adhesive to embossments 601, 602 and 603 and finally the two web-shaped materials are combined in a nip 561.

The embossing pattern of the first embossing roll could be chosen to be a design embossing. A design embossing normally comprises decorative elements, like e.g. flowers, leaves, logos etc. One decorative element could comprise different parts. In the examples above in FIGS. 1 to 4, a flower was formed by an embossment for stem, an embossment for petals and an embossment for centre. The embossments were then line-shaped. It is also possible to make design embossing by an arrangement of dot-shaped embossments. Dot-shaped elements can also form an appealing geometrical pattern. It is also possible to combine decorative elements with dot-shaped elements. In a typical design embossing, between 2 and 15% of the total surface area is embossed.

It would be possible to treat the web-shaped materials individually before combining them. An example is background embossing all over the surface or over parts of the surface. By background embossing is meant an embossing which is not primarily decorative, but instead has the purpose of influencing the material's physical properties, like softness or absorption, or giving the surface a visual structure, i.e. a textile-look. If the embossing is made before combining the web-shaped materials, it is called pre-embossing. The web-shaped materials could also be printed individually, or a chemical like a lotion or a wetting agent could be applied.

It is also possible to combine design embossing and background embossing. The embossing pattern of the first embossing roll could for example have protrusions with two different heights, a so called double-height embossing roll. The high protrusions would form the decorative elements and the lower protrusions would form a background embossing. Embossments formed by the high protrusions could be printed and glued in the subsequent steps, while the embossments formed by the lower protrusions normally remain unprinted and unglued. The embossing roll could also have protrusion with three different heights, a so called triple-height embossing roll. It is also possible to have an embossing roll with a true three-dimensional surface.

After combination of the web-shaped materials, the combined web 3, 503, 704 could be treated in many ways known within converting of web-shaped materials, for example paper or nonwoven. The combined web could be embossed in a subsequent step. The combined web could be printed on the outside. The outside print could be in register with the inside print or not in register. If the outside print is in register, the combined web could be printed while still residing on the first embossing roll 4, 504, 705. Another way could be to keep an outside print in register with the inside print/coloured adhesive by means of an electronic or mechanical control arrangement. The combined web can in subsequent process steps be perforated and/or cut. It might be folded or rolled up as rolls having a suitable size for the user.

The descriptions above mention ink and adhesive. It would also be possible to apply other chemicals like e.g. wetting agents, bleaching agents or lotion. These can then be applied in register or out of register, with the web residing on the first embossing roll 4, 504, 705, on the webs individually or on the combined web. Since it is possible to keep perfect register, unwanted mixing of chemicals with each other or with glue or ink can be avoided. These chemicals might be applied to what will be the outside of the combined web or might be applied so that they stay inside the combined web.

The invention also comprises the use of three, four, five or more web-shaped materials, which are combined to a web-shaped web. The web-shaped materials could have different paths through the device. They could follow the first or second web-shaped material through the device. The web paths could also be arranged so that they partly follow either the first or second web-shaped material.

The web-shaped materials could be the same or they could have different properties, for example different grammage, different stretch, different colour, different background embossing or being of different raw material, like at least one being tissue paper and one nonwoven. Since ink and/or coloured adhesive is applied on the inside of the first web-shaped material, at least one of the web-shaped materials 1 and 2 should be at least partly transparent, so that colour can be seen through the material.

Also, when using web-shaped materials with different colours, it might be wanted that at least one of the web-shaped material facing outwards should be transparent enough to let the colour of another web-shaped material shine through. For example, when making a three-ply product, with uncoloured outer plies and a coloured mid-ply, the mid-ply should shine through. If the mid-ply is blue, the whole product would look bluish. This could further be enhanced by using blue ink or glue colour.

In a preferred embodiment, when using more than two web-shaped materials, the additional web-shaped materials situated in-between the outer web-shaped materials are used to give extra thickness to the multi-ply web. This can be achieved by for example embossing the additional web-shaped materials before combining them with the outer web-shaped materials. Normally such an embossing is done over the whole surface of the additional web-shaped materials or over large parts of the surface. The embossing should be deep, so that the thickness is substantially increased.

Additional web-shaped materials could also be added before or after the whole unit as for example described in FIG. 1.

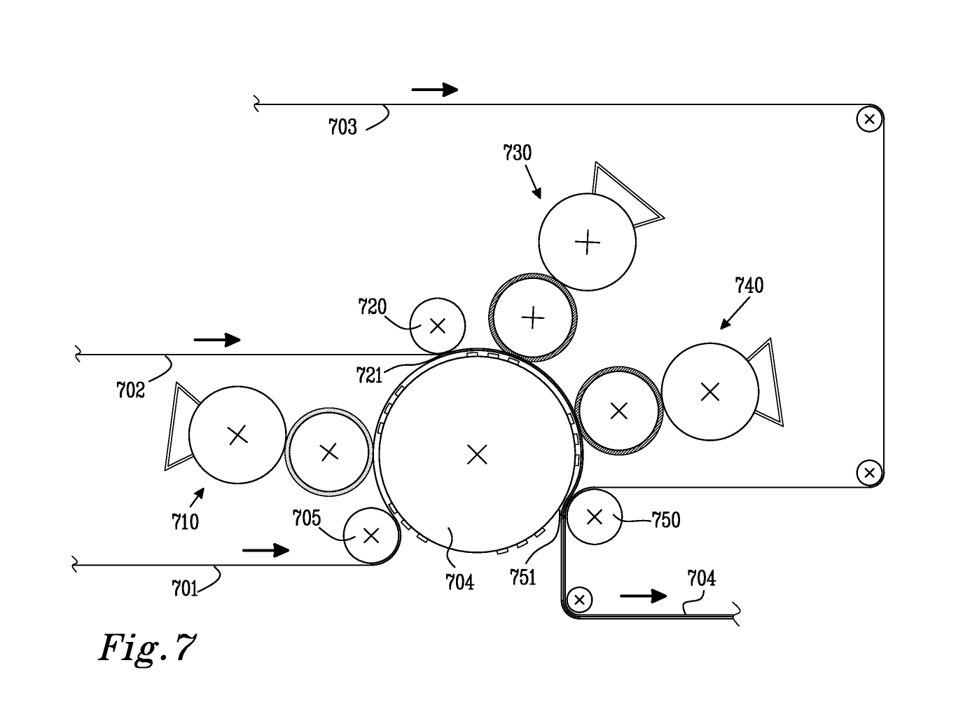

FIG. 7 shows an example with three web-shaped materials. The first web-shaped material 701 is embossed between a first embossing roll 705 and a counter roll 706. It is then printed in a printing unit 710. A third web-shaped material 702 is combined to the first web-shaped material in a nip 721 between the first embossing roll 705 and a counter roll 720. The combined web is then printed in printing unit 730 and glued in adhesive application unit 740. A second web-shaped material 703 is combined to the other two web-shaped materials in the marrying nip 751 between the first embossing roll 705 and the marrying roll 750. The resulting product will have prints between the first and third web-shaped material and adhesive between the second and third web-shaped materials. The adhesive is preferably made so that it will penetrate through the middle material and glue all three materials together, but alternatively an additional adhesive application unit can be placed before the nip 721 where the first and third web-shaped materials are combined. Counter roll 720 and printing unit 721 are optional.

Sometimes, when producing multi-ply materials, it is difficult to make the adhesive penetrating enough to fasten all web-shaped materials, especially for high grammage materials. It might then be necessary to use additional adhesive application units. For example, when producing a five-ply material, three plies are fed together to form the first web-shaped material 701. The three plies are then embossed and printed. Thereafter an additional adhesive application unit (not shown in FIG. 7) is applying adhesive to a subset of the set of embossments. It would also be possible to exchange printing unit 710 to an adhesive application unit. The fourth ply is supplied like the third web-shaped material 702 of FIG. 7. Printing on the fourth ply is optional. Thereafter an adhesive is applied and the fifth ply is provided as the second web-shaped material 703. Ply-bonding would be enhanced, if there is an extra marrying step after adding the fourth ply.

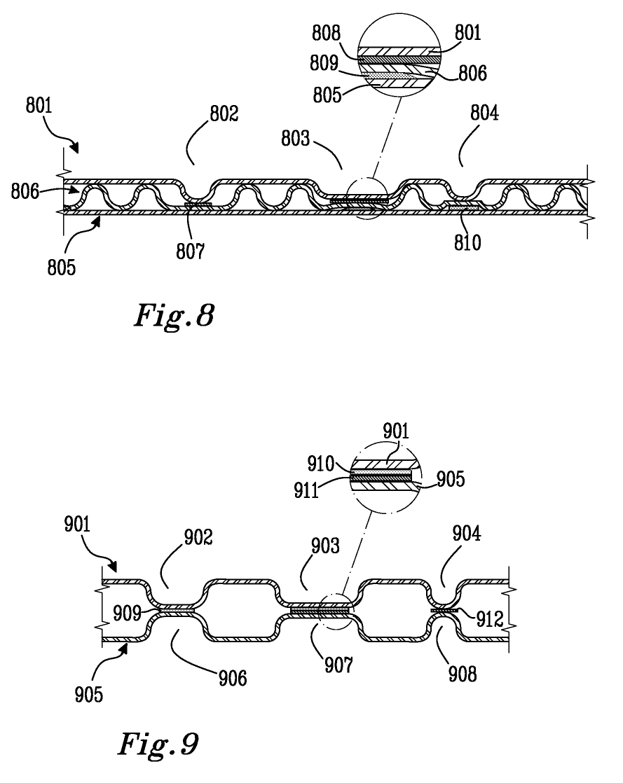

In a preferred embodiment, a multi-ply product could look like FIG. 8. The first outer ply 801 has embossments 802 to 804. Embossments 802 and 803 belong to the first subset of embossments and are printed in ink areas 807 and 808. Subsequently, one, two, three or more middle ply/plies is/are added. The middle ply/plies has/have been embossed with a so called volume embossing before being combined with the first outer ply. The main purpose of the volume embossing is to add substantially to the thickness of the product. The thickness of the volume embossed ply/plies is thus substantially increased in the volume embossing step. Preferably, volume embossing is performed as a pre-embossing.

In the next step, an adhesive is applied to a second subset of the set of embossments of the middle ply/plies, which now lie on the first outer ply. The adhesive should preferably be able to penetrate through the middle ply/plies to attach all plies to each other. This is seen in FIG. 8 as adhesive areas 809 and 810. The second outer ply 805 is substantially flat, reflecting how a multi-ply product, which has been married between the first embossing roll and a flat marrying roll, would look like.

In the above described embodiments, combining of the web-shaped material is made in a nip between a first embossing roll and a flat counter roll. In alternative embodiments it is possible to combine the web-shaped material with other known lamination technologies like foot-to-foot, nested or union. It would also be possible to combine the two web-shaped materials by e.g. spraying an adhesive in-between the plies.

Foot-to-foot, also known as tip-to-tip or pin-to-pin, comprises the steps of embossing the second web-shaped material on a second embossing roll. The second embossing roll has protrusions, which at least partly correspond to those of the first embossing roll 4. After embossing, the web-shaped materials are combined so that a substantial part of the embossments of the first web-shaped material meets a substantial part of the embossments of the second web-shaped material. Therefore the embossing pattern of the second embossing roll must match the embossing pattern of the first embossing roll. The match could be done in the same way as described above for the printing roll. As described above, a second subset of the set of embossments of the first web-shaped material is glued. If such a glued embossment meets an embossment of the second web-shaped material, the two embossments are glued together. By the term substantial parts above, it is meant that enough embossments must be glued to keep the plies together.

FIG. 9 shows a cross section of a combined web material made according to an embodiment comprising foot-to-foot lamination. The first web-shaped material, forming the first outer ply 901, has a number of embossments 902, 903 and 904. The second web-shaped material, forming the second outer ply 905, has embossments 906, 907 and 908. When the first web-shaped material was on the first embossing roll, the embossments 902 and 903 were printed, seen as ink areas 909 and 910. Embossments 903 and 904 were glued, seen as adhesive areas 911 and 912. The adhesive attaches embossments 903 to 907 and 904 to 908.

In an embodiment using nested lamination, the second web-shaped material is embossed on a second embossing roll having protrusions giving embossments in the second web-shaped material where a majority of the embossments of the second web-shaped material are in-between the embossments of the first web-shaped material, when the materials are combined. The embossing of the second web-shaped material is done in a separate nip between the second embossing roll and an additional counter roll. The embossing pattern of the second embossing roll must match the embossing pattern of the first embossing roll, so that the embossments will “nest” as described. The match could be done in the same way as described above for the printing roll.

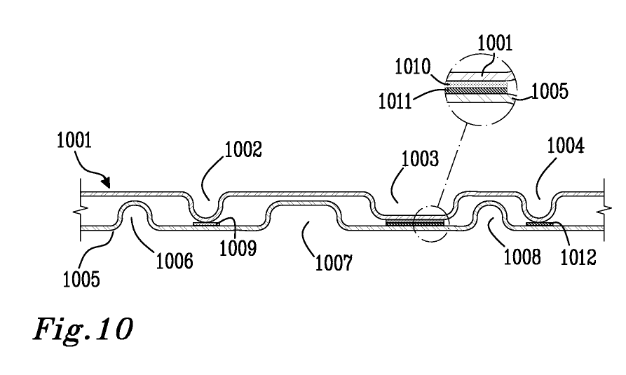

FIG. 10 shows a cross section of a web-shaped material made according to an embodiment comprising either nested lamination. The first web-shaped material, forming the first outer ply 1001, has a number of embossments 1002, 1003 and 1004. The second web-shaped material, forming the second outer ply 1005, has embossments 1006, 1007 and 1008. When the first web-shaped material was on the first embossing roll, embossments 1002 and 1003 were printed, seen as ink areas 1009 and 1010. Embossments 1003 and 1004 were glued, seen as adhesive areas 1011 and 1012. The adhesive attaches embossments 1003 and 1004 to substantially flat sections of the second web-shaped material. Embossment 1002 lies against a flat section of the second web-shaped material 1005. The embossments 1006, 1007 and 1008 lie against substantially flat sections of the first web-shaped material 1001.

In a further alternative embodiment, the combination of web-shaped materials is done in a separate unit not being in contact with the first embossing roll.

1-25. (canceled)

26. A method for producing a multi-ply web of tissue paper or nonwoven, which comprises the steps of:
embossing a first web-shaped material in a nip between a first embossing roll and a counter roll, thereby creating a set of embossments;
applying a first ink with a first colour to a first subset of said set of embossments of said first web-shaped material while the material still resides on said first embossing roll;
applying an adhesive to a second subset of said set of embossments of said first web-shaped material while said first web-shaped material still resides on said first embossing roll;
combining said first web-shaped material with a second web-shaped material to form a multi-ply web while said first web-shaped material resides on the first embossing roll.

27. The method according to claim 26, wherein the adhesive is coloured with a second colour.

28. The method according to claim 26, wherein an additional colour is applied as an ink or a coloured adhesive to at least one additional subset of said set of embossments of said first web-shaped material while said material still resides on said first embossing roll in an additional application unit before combining said web-shaped materials.

29. The method according to claim 26, wherein the subsets of the set of embossments at least partly coincide.

30. The method according to claim 27, wherein the colours are mixable with each and that the mixed colours have shades that are perceived different from the applied colours.

31. The method according to claim 26, wherein the inks are applied by flexographic printing.

32. The method according to claim 26, wherein at least one of the first and second web-shaped material or the combined multi-ply web is embossed or printed before and/or after the recited steps.

33. The method according to claim 26, wherein the web-shaped materials are combined by marrying in an nip between the first embossing roll and a marrying roll having a substantially flat surface, using foot-to-foot technology or using nested technology.

34. The method according to claim 26, wherein at least one additional web-shaped material is added before the step of combining.

35. The method according to claim 26, wherein at least one web-shaped material has been embossed over at least parts of its surface giving said web-shaped material an embossed thickness which is substantially adding to the thickness of the multi-ply web.

36. A device for producing a multi-ply web of tissue paper or nonwoven, comprising:
a first embossing roll having a three dimensional first pattern of protuberances;
a counter roll arranged to run against said first embossing roll;
at least one printing unit arranged to run against said first embossing roll;
at least one adhesive application unit arranged to run against said first embossing roll; and
a least one unit for combining different plies of said web comprising a marrying roll arranged to run against said first embossing roll.

37. The device according to claim 36, wherein at least one printing roll is adapted to carry an ink in a first pattern, whereby the ink-carrying regions coincide with a first subset of the protuberances of the first embossing roll.

38. The device according to claim 36, wherein at least one adhesive application roll is adapted to carry an adhesive in a second pattern, whereby the adhesive-carrying regions coincide with a second subset of the protuberances of the first embossing roll.

39. The device according to claim 36, wherein the device comprises three or four printing rolls and an adhesive application roll, all placed before the last unit for combining.

40. A printed and embossed multi-ply web of tissue paper or nonwoven, with at least a first outer ply having a first pattern formed by a set of embossments, facing inwards in the web, wherein at least a first subset of said set of embossments is printed with a first ink having a first colour and at least a second subset of said set of embossments is glued by an adhesive to a second ply, the ink and adhesive being applied in synchronization with the subsets of said set of embossments, and the geometrical relation between the first and second subsets of said set of embossments repeating in a regular way.

41. The printed and embossed multi-ply web as claimed in claim 40, wherein the embossments of the first and second subset of the set of embossments have substantially the same depth.

42. The printed and embossed multi-ply web as claimed in claim 40, wherein the adhesive is coloured.

43. The printed and embossed multi-ply web as claimed in claim 40, wherein at least one additional subset of the set of embossments is printed with at least one additional ink having an additional colour.

44. The printed and embossed multi-ply web as claimed in claim 40, wherein the subsets of the set of embossments at least partly coincide.

45. The printed and embossed multi-ply web as claimed in claim 42, wherein the perceived colours of the embossments is a mix of the applied colours, where the subsets of the set of embossments coincide.

46. The printed and embossed multi-ply web as claimed in claim 40, wherein the embossments in the first outer ply form a design embossing.

47. The printed and embossed multi-ply web as claimed in claim 40, wherein at least one of the plies comprises a background embossing, in addition to the glued and printed embossments.

48. The printed and embossed multi-ply web as claimed in claim 40, wherein a second outer ply is substantially flat or has a background embossing, and is attached to the first outer ply by means of nested technology, foot-to-foot technology or flat marrying.

49. The printed and embossed multi-ply web as claimed in claim 40, comprising at least one additional ply.

50. The printed and embossed multi-ply web as claimed in claim 40, wherein at least one ply is embossed over at least parts of its surface giving said ply an embossed thickness which is substantially adding to the thickness of the multi-ply web.
